(19) United States
(12) Patent Application Publication
(10) Pub. No.: US 2007/0246871 A1
(43) Pub. Date: Oct. 25, 2007

(54) Vibration Isolation Table Device

(75) Inventor: Akihiro Hayashi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Fujikura Rubber Ltd., Shinagawa-ku (JP)

(21) Appl. No.: 11/630,684

(22) PCT Filed: Sep. 7, 2005
(86) PCT No.: PCT/JP05/16878

§ 371 Date: Dec. 27, 2006

(30) Foreign Application Priority Data
Sep. 14, 2004 (JP) 2004-266468

(51) Int. Cl. F16F 15/00

(52) U.S. Cl. 267/140.12

(57) ABSTRACT

A vibration isolation table device of the present invention is provided with a top plate directly or indirectly contacting an object to be vibration-isolated, suspending plates suspending from peripheral edges of the top plate, and a base member covered by the top plate and the suspending plates, wherein a perpendicular fluid spring and a fluid bearing are disposed subsequently between an inside surface of the top plate and the base member to be directed from the base member toward the inside surface of the top plate, a horizontal fluid spring is disposed between an inside surface of at least one of the suspending plates and the base member, and after the floating of the top plate and the suspending plates by the perpendicular fluid spring and performing a leveling operation, the top plate is floated in a non-contact state so that friction in the horizontal direction is made substantially zero at very soft condition, and accordingly, soft spring characteristics are provided in the perpendicular and horizontal directions and an improved positioning stability can be obtained.

### BACKGROUND OF THE INVENTION

1. Field of the Invention

The present invention relates to a vibration isolation table device, more specifically, to a vibration isolation table device provided directly or indirectly for an object to be vibration-isolated and adapted to suppress the vibration of the object, and more in detail, the present invention relates to a vibration isolation table device for a precision instrument for suppressing micro-vibration from a floor or a self-vibration of the device itself.

2. Prior Art

In a known art, for example, for a semi-conductor manufacturing device, when a memory or an IC is manufactured, a stepper provided with a baking or printing device for printing the memory or IC on a wafer substrate by applying a photographing technology. In an actual usage of the stepper, it is necessary to quickly and precisely move and position the wafer substrate or printing device to a predetermined position.

However, more quick transfer, stop or like motion inevitably causes a problem of generation of vibration to the stepper. Particularly, in a specification of design required today for an IC requiring high integration, even in generation of a micro-vibration, there may cause a problem of duplicated formation of circuit line or short-circuiting (called generation of circuit-doubling). In order to eliminate such problems, in a prior art, many vibration isolation table devices or like for suppressing or damping the vibrations of the stepper have been proposed.

For example, in order to isolate the micro-vibration from a floor in a precision instrument and to maintain a constant position, the vibration isolation table device is conventionally provided with a various fluid spring units (i.e., mainly air spring) for achieving vibration suppression or damping function. More specifically, a vibration isolation table device utilizing a diaphragm-type or bellows-type fluid spring has been used.

However, the use of the diaphragm-type fluid spring as a spring in a perpendicular direction provides a soft spring in the perpendicular direction but a hard spring in a horizontal direction, providing a problem.

In order to solve such problem, there is also provided a pendulum-type spring such as gimbal piston or a horizontal soft spring having a spherical body to support a load.

However, the inclusion of such a spherical body may cause a fear of generating a recess or injury to a contacting surface to an object, which may not result in obtaining of desired performance or characteristic.

On the other hand, with the bellows-type fluid spring, it has a relatively soft spring in both the perpendicular and horizontal directions. However, with respect to a delicate characteristic which is required in these days (especially, horizontal soft spring characteristic), such bellows-type fluid spring provides itself no sufficient characteristic. That is, in a case where film rigidity is reduced or film portion is enlarged for providing an extremely soft spring in the horizontal direction, the spring lacks in stability, being inconvenient for stable positioning thereof.

Furthermore, Japanese Patent Unexamined Application Publication No. HEI 5-321979 will be provided as a material showing a technique similar to that of the present invention. However, this is proposed for showing a structure in which only a horizontal translational vibration is maintained with respect to action of a step external force in the horizontal direction and a vibration in the perpendicular direction is restricted. Such structure is different from the present invention which requires a soft spring characteristic in both the perpendicular and horizontal directions.

The present invention was conceived in consideration of the circumstances mentioned above and an object thereof is to provide a vibration isolation table device having a soft spring characteristic in both perpendicular and horizontal directions and being excellent in positioning stability.

### DISCLOSURE OF THE INVENTION

The present invention for achieving the above object is a vibration isolation table device disposed directly or indirectly with respect to an object to be vibration-isolated for isolating vibration of the object, the vibration isolation table device comprising: a top plate directly or indirectly contacting the object; suspending plates suspending from peripheral edges of the top plate; and a base member covered by the top plate and the suspending plates, wherein a perpendicular fluid spring and a fluid bearing are disposed sequentially between an inside surface of the top plate and the base member to be directed from the base member toward the inside surface of the top plate, a horizontal fluid spring is disposed between an inside surface of at least one of the suspending plates and the base member, and after the floating of the top plate and the suspending plates by the perpendicular fluid spring and performing a leveling operation, the top plate is floated in a non-contact state by the fluid bearing.

In a preferred embodiment, the fluid bearing may have substantially a cylindrical structure having an inner hollow portion, one substantially circular plane area, which contacts the inside surface of the top plate, of the cylindrical structure is formed as a porous sintered surface, another one substantially circular plane area opposing to the above-mentioned one circular plane area substantially contacts the perpendicular fluid spring, and pressurized fluid for the fluid bearing is supplied into the hollow portion of the cylindrical structure from the outside thereof.

Further, in a preferred embodiment, the perpendicular fluid spring may be composed of a diaphragm having a rolling operation film structure or a bellows.

Further, in a preferred embodiment, the perpendicular fluid spring and the fluid bearing interposed between the inside surface of the top plate and the base member may be arranged so as to support a load in the perpendicular direction, and the horizontal fluid spring interposed between the inside surface of the suspending plate and the base member is for horizontal positioning.

Further, in a preferred embodiment, the top plate and the suspending plates may be integrated as floating structure and the base member has a function of fixing member.

Further, in a preferred embodiment, the perpendicular fluid spring may be a diaphragm having a rolling operation film structure, in which: the base member is provided with a base member body having a fluid chamber, a flange member covering the base member body in a state communicated with the fluid chamber, and a cylinder constituting member integrally secured to a peripheral edge portion of the flange member; in combination of the flange member and the cylinder constituting member, the peripheral flange portion of the diaphragm is fixed and a cylinder portion of the rolling operation film is formed; and the fluid bearing constitutes a piston portion of the rolling operation film.

Further, in a preferred embodiment, pressurized fluid for the fluid spring may be introduced into the fluid chamber formed to the base member body from an outside thereof, and the introduction of the pressurized fluid permits the rolling operation film to carry out rolling motion and permits the fluid bearing to vertically move.

Further, in a preferred embodiment, the perpendicular fluid spring may be a bellows, in which: the bellows is provided with a pair of opposing ring-shaped surface portions and a side surface portion disposed so as to connect outer peripheral edge portions of the respective opposing surface portions to each other; the base member is provided with a base member body having a fluid chamber, and one of the ring-shaped opposing surface portions of the bellows is fixed onto the base member body in a state communicated with the fluid chamber; and another one of the ring-shaped opposing surface portions is substantially fixed to the fluid bearing.

Further, in a preferred embodiment, pressurized fluid for the fluid spring may be introduced into the fluid chamber formed to the base member body from an outside thereof, and the bellows is expanded in an axial direction according to the introduction of the pressurized fluid so as to vertically move the fluid bearing.

Further, in a preferred embodiment, the horizontal fluid spring formed between an inside surface of at least one of suspending plates and the base member may be either one of diaphragm having a rolling operation film structure, a bellows and a piston structure.

Further, in a preferred embodiment, the horizontal fluid spring and the fluid bearing may be disposed sequentially between the inside surface of at least one of the suspending plates and the base member to be directed from the base member toward the inside surface of the suspending plate, and a non-contact state from the suspending plate is formed by the fluid bearing.

### BRIEF DESCRIPTION OF THE DRAWINGS

FIG. 1 is a sectional half view of a vibration isolation table device according to one preferred embodiment of the present invention;

FIG. 2 is a plan view of FIG. 1;

FIG. 3 is a sectional half view for explaining an operation of the vibration isolation table device according to the present invention;

FIG. 4 is a sectional half view for explaining an operation of the vibration isolation table device according to the present invention;

FIG. 5(A) is a front view showing a state in which the vibration isolation table device is disposed directly or indirectly below a plate-shaped stepper support table on which a stepper as an object is placed, and FIG. 5 (B) is a plan view of FIG. 5(A); and

FIG. 6 is a perspective view showing one example of a bellows.

### DETAILED DESCRIPTION OF THE INVENTION

Hereunder, an embodiment of the present invention will be described in detail.

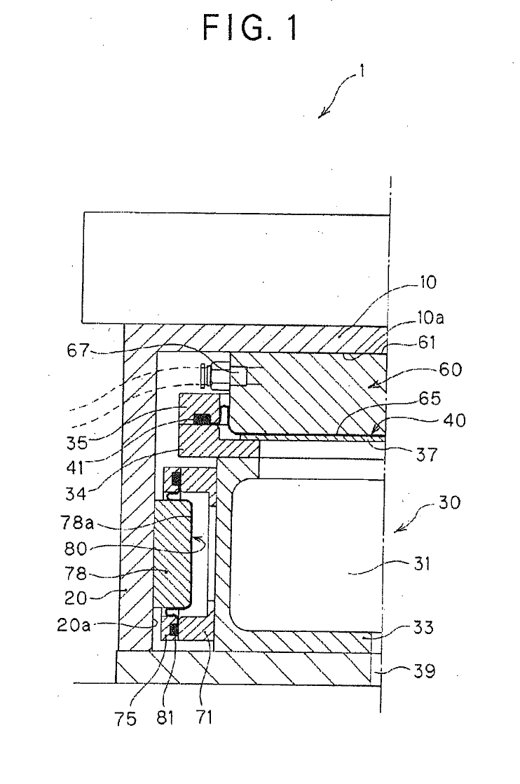

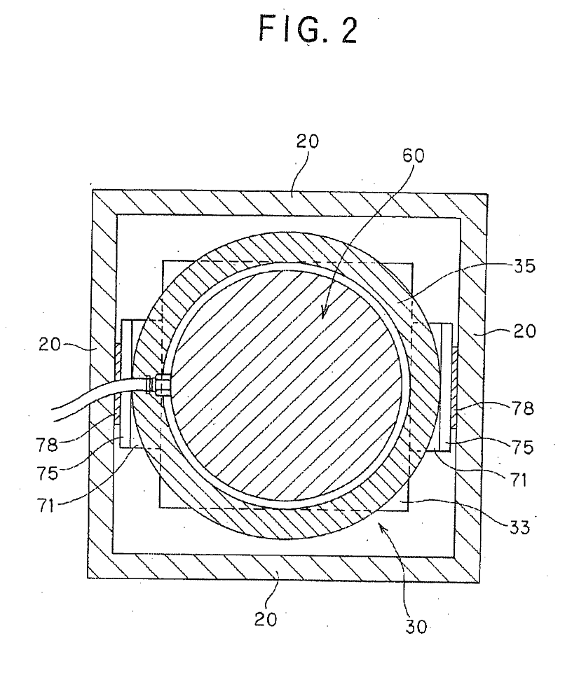

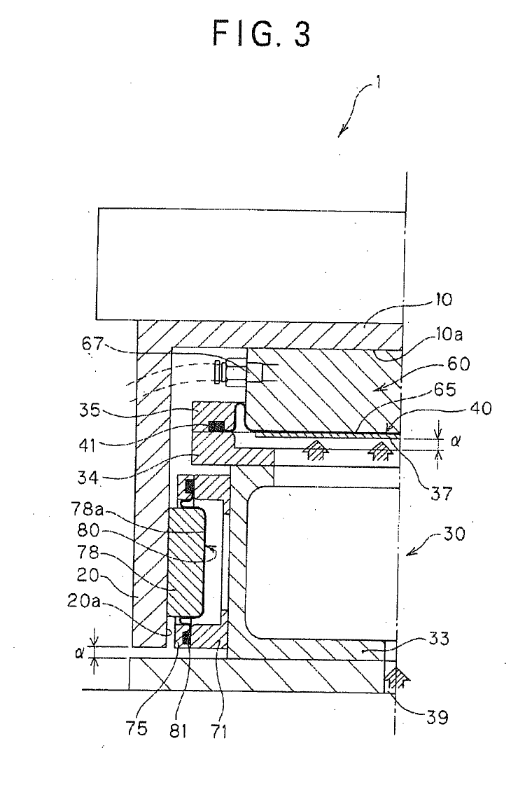

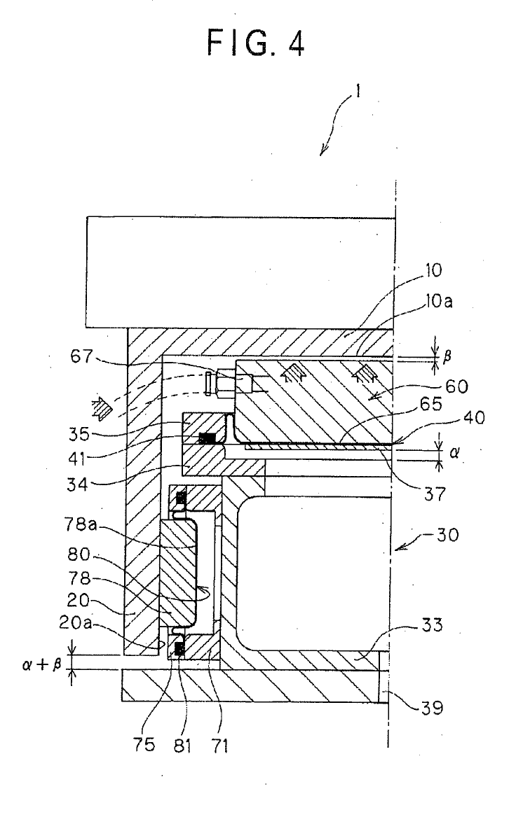

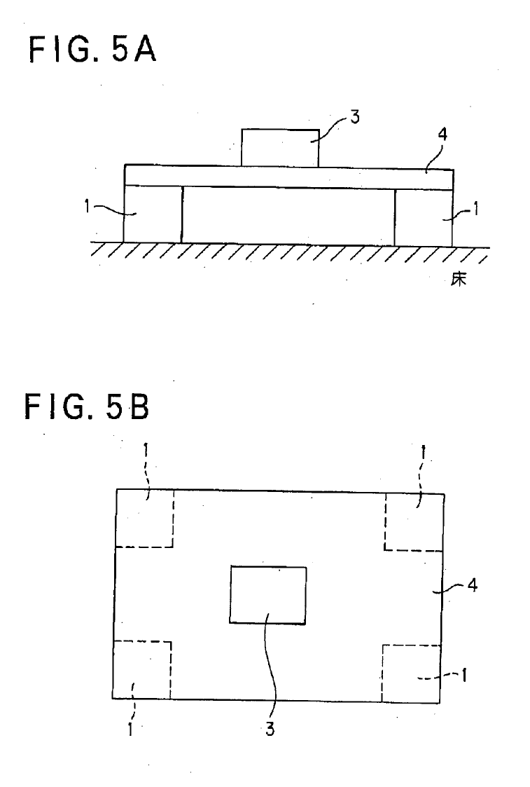

FIG. 1 is a sectional half view of a vibration isolation table device 1 according to one preferred embodiment of the present invention. FIG. 2 is a schematic plan view of FIG. 1 (further, a top plate which will be mentioned hereinlater is removed for easy understanding of an inner structure). FIGS. 3 and 4 are sectional half views for explaining an operation of the vibration isolation table device 1 according to the present invention. FIGS. 5(A) and 5(B) are front and plan views showing one example of the vibration isolation table device in use thereof.

The vibration isolation table device 1 according to the present invention is disposed directly or indirectly below a plate-shaped stepper support table 4 on which a stepper 3 is rested, for example, as an object, to which transferring of vibration is isolated (which may be called “object to be vibration-isolated” or merely “object”, hereinlater), as shown in FIGS. 5(A) and (B). The vibration isolation table device 1 is for removing or suppressing vibration generated by the stepper 3 or for preventing or suppressing transfer of vibration from a floor to the stepper 3.

Usually, three or more vibration isolation table devices 1 are utilized in consideration of the stable arrangement at positions suitable for stably supporting the load.

### Preferred Embodiment of Vibration Isolation Table Device of the Invention

The vibration isolation table device 1 as shown in FIG. 1 is provided with a top plate 10 having approximately rectangular shape, for example, which directly or indirectly contact to the object, vertical, i.e., suspending, plates 20 extending vertically from peripheral edges of the top plate 10, and a base member 30 covered by the top plate 10 and the suspending plates 20.

The top plate 10 and the suspending plates 20 are usually integrated and serve as so-called “floating portion” for isolating vibration in a floating state in the vibration isolation table device 1. The base member 30 serves as “fixed portion” utilized in a state fixed to the floor in the vibration isolation table device 1.

In the vibration isolation table device 1 of the present invention, as shown in FIG. 1, a fluid spring 40 (usually, air spring) directed perpendicularly toward an inside surface 10a of the top plate 10 from the base member 30, and a fluid bearing 60 (usually, air bearing) are disposed in the described order. The perpendicularly directed fluid spring 40 is interposed between the inside surface 10a of the top plate 10 and the upper portion of the base member 30 for supporting the load in the perpendicular direction.

Further, as shown, a fluid spring 80 (usually, air spring) directed horizontally is disposed between an inside surface of at least one suspending plate 20 and a side surface of the base member 30, and this horizontally directed fluid spring 80 is arranged mainly for the purpose of position control of the body of the vibration isolation table device 1. The horizontally directed fluid spring 80 may be properly arranged, as shown in FIG. 5, so as to easily control the vibration isolation in accordance with layout of the entire vibration isolation table device 1. Accordingly, it is not necessary to arrange the horizontally directed fluid spring 80 so as to entirely surround the outer peripheral portion of the base member 30 shown in FIG. 1.

The vibration isolation table device 1 of the structure mentioned above is subjected to leveling operation by floating the top plate 10 and the suspending plates 20 by the operation of the fluid spring 40, and thereafter, the top plate 10 is floated in a non-contact state by the operation of the air bearing 60. These operations will be explained hereinlater.

It is desirable that the perpendicularly directed fluid spring 40 is formed from a diaphragm having rolling operation film structure made of cloth-inserted rubber or bellows made of cloth-inserted rubber. A metal bellows may be also utilized. The embodiment of FIG. 1 includes a diaphragm 40 as one preferred example of the perpendicularly directed fluid spring 40.

In the embodiment shown in FIG. 1, the base member 30 is provided with a rectangular base body 33 in which a fluid chamber 31 is formed, and an approximately ring-shaped recessed flange member 34 is mounted on the upper side of the base body 33 so as to communicate with the fluid chamber 31. In addition, an approximately ring-shaped cylinder constituting member 35 is fixed to the peripheral edge portion of the flange member 34, and by the combination of the flange member 34 and the cylinder constituting member 35, the peripheral edge flange portion 41 of the diaphragm 40 is snapped and secured, thus constituting a cylinder portion to which the rolling operation film functions. On the other hand, the fluid bearing 60 abutting against the diaphragm 40 in a rested state serves as a piston for the rolling operation film.

In other wards, according to the rolling motion of the diaphragm 40, the fluid bearing mounted to the diaphragm 40 is vertically moved. That is, it is constructed that a pressurized fluid for the fluid spring is introduced from the outside into the fluid chamber 31 formed to the base member body 33 through a port 39 described in FIG. 1 at the lower central portion thereof, and the rolling operation film of the diaphragm 40 rolls and moves by the introduction of the pressurized fluid so as to lift up the fluid bearing 60.

More in detail, the rolling operation film (namely, convolution portion which is a working area of diaphragm) of the diaphragm 40 has a structure capable of causing the rolling moving by the sliding motion between the cylinder and the piston to thereby support the substantial load in the perpendicular direction.

The rolling operation film is so-called “diaphragm” having a bottomed cylindrical member, and through fold-back mounting, providing a long stroke and deep convolution, and it is possible for the diaphragm to keep constant effective pressure-receiving area during the operation. That is, the rolling operation film is provided with a fold-back portion, and when pressure is applied to the surface of the rolling operation film, most portions of the film surface is pushed against the working film surfaces of the cylinder and the piston and remaining fold-back bottom portion is pressure-balanced by a tension stress due to the pressure.

In the described embodiment, the peripheral flange portion 41 of the rolling operation film is fixed by the combination of the flange member 34 and the cylinder constituting structure 35, and the bottom portion of the rolling operation film is fixed to a top portion (a portion corresponding to the piston head 65 of the fluid bearing 60) of the piston by a retainer plate 37.

For example, the cloth-inserted rubber rolling operation film is formed into extremely thin thickness, and in an actual structure, rubber is applied on a strong polyester (Tetron) cloth or like.

In the fluid chamber 31 of the base member 30, there is supplied, from the outside thereof, fluid through the inlet port 39, and the fluid chamber 31 is communicated with an operation space defined between the cylinder and the piston so that the rubber operation film can perform the rolling movement. The provision of such fluid chamber 31 makes large the substantial inner volume and small the spring constant in the perpendicular direction.

The fluid bearing 60 has a substantially hollow cylindrical structure having a pair of opposing circular plane areas including one circular plane area 61, which may contact the inner surface 10a of the top plate 10, is formed from a porous sintered surface. The other circular plane area 65 opposing to that 61 constitutes a piston head 65, which is in contact with (rested state) the diaphragm 40 as the fluid spring. A pressurized fluid for the fluid bearing is supplied from the outside into the hollow inner space of the fluid bearing 60 through an inlet port 67. When the pressurized fluid is introduced into the fluid bearing, the pressurized fluid jets outward thereof through the porous surface of the circular plane area 61 of the porous sintered surface, thus allowing the top plate 10 to float in non-contact state.

Incidentally, as mentioned before, in the vibration isolation table device 1 of the present invention, a horizontal directional fluid spring 80 is interposed between the inside surface 20a of at least one suspending plates 20 and the base member 30. As such horizontal directional fluid spring 80, one preferred example of diaphragm 80 having the rolling operation film structure is shown in FIG. 1.

That is, a cylinder constituting member 71 having the cylindrical recessed structure is secured to the side surface of the base member 30, and the flange member 75 is also secured to the peripheral edge portion of the cylinder constituting member 71. In combination of such flange member 75 and the cylinder constituting member 71, a peripheral edge flange portion 81 of the diaphragm 80 is snapped and fixed, and a cylinder structure, in which the rolling operation film functions, is provided. On the other hand, the piston member 78 is fixed to the inside surface 20a of the perpendicular plate 20 in a manner such that a piston head 78a of the piston member 78 is covered by the diaphragm 80.

Further, a bellows or piston structural member (i.e., fluid cylinder structure) may be utilized as the horizontal directional fluid spring 80 instead of diaphragm 80. A cloth-inserted rubber or metal bellows may be utilized as such bellows.

Moreover, it may be adopted that the horizontal directional fluid spring 80 and the fluid bearing, not shown, may be disposed in this order between the inside surface 20a of the suspending plate 20 and the side surface of the base member 30 toward the former from the latter so as to create non-contact state to the suspending plate with substantial no friction. In this case, the spring constant in the perpendicular direction may be further lowered. Further, as the structure adopting such a fluid bearing, it may be supposed that the piston member 78 in FIG. 1 is substituted with a fluid bearing and is released from the fixture to the inside surface 20a of the suspending plate 20 in a free state. The fluid jetting side may constitute the inside surface (20a) side.

### Explanation of Operation of Vibration Isolation Table Device of FIG. 1

In the state shown in FIG. 1, the perpendicular fluid spring 40 and the fluid bearing 60 do not operate.

Next, as shown in FIG. 3, the pressurized fluid for the fluid spring is fed into the fluid chamber 31 formed to the base member body 33 from the outside thereof through the inlet port 39. According to this introduction of the pressurized fluid, the rolling operation film of the diaphragm 40 performs the rolling movement to thereby lift up the fluid bearing 60. When the fluid bearing 60 is lifted upward, the floating structure including the top plate 10 is also lifted upward. In this floating, the floating distance from the rested standard position is represented as “α” in FIG. 3.

Then, the pressurized fluid for the fluid bearing is fed into the hollow space of the fluid bearing 60 from the outside thereof through the inlet port 67. When the pressurized fluid for the fluid bearing is supplied, the pressurized fluid is jetted outward from the porous surface on the circular plane area 61 constituted by the porous sintered surface, and the top plate 10 then floats upward by a distance “β” in the non-contact state (FIG. 4).

That is, the operation is carried out so that the top plate 10 floats upward in the non-contact state. In this moment, the floating distance from the rested standard position is “α+β” (FIG. 4). Further, in the drawing, this distance is expressed in an exaggerated state for the easy understanding of the floating state, and in an actual state, the distance α is about several mm and the distance β is about several microns, and less influence is applied to the axial direction of the horizontal fluid spring 80 secured to the fixed piston member 78.

### Explanation of Modified Example of Vibration Isolation Table Device of The Invention

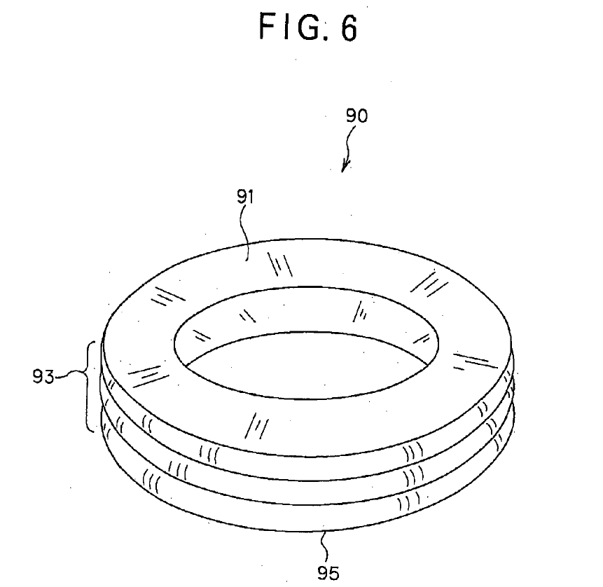

As the perpendicular fluid spring 40, in substitution for the diaphragm 40 shown in FIG. 1, a bellows 90, shown in FIG. 6, having one or more than one stage (for example, three-stage bellows as shown) may be utilized. In this example, the bellows 90 is provided with a pair of ring-shaped opposing surface portions 91 and 95 and a side surface portion 93 (for example, a bellows-shaped wall surface portion 93) disposed so as to connect outer peripheral edges of these opposing surface portions 91 and 95. In a form of bellows made of cloth-inserted rubber, for example, a continuous cloth is embedded in the paired opposing surface portions 91 and 95 and the bellows-shaped wall surface portion 93 of the bellows 90.

The basic concept of this preferred modified embodiment is to realize substantially the same functions even if the diaphragm 80 of FIG. 1 is substituted with the cloth-inserted rubber bellows 90 (FIG. 6). That is, one of the paired ring-shaped opposing surface portions 95 of the bellows 90 is substantially fixed onto the base member body 33 and the other one surface portions 91 is substantially fixed to the lower surface portion of the fluid bearing 60 in a state of being communicated with the fluid chamber 31. Herein, the ward “substantially” means that it includes a case wherein the bellows may be indirectly fixed by way of newly added fixing member without being limited to a direct fixing method. This is because that the fixing is not stable as far as the opposing surface portions 91 and 95 are maintained as they are.

In the present invention of the characters mentioned above, there can be provided a vibration isolation table device excellent in the positioning stability as well as capable of having a soft spring characteristic in the perpendicular and horizontal directions.

That is, the provision of the perpendicular fluid spring makes it possible to float the load and set the standard level, and the provision of the fluid bearing makes it possible to float the load in the non-contact state and to make substantially zero the friction in the horizontal direction. Accordingly, the spring constant in the horizontal direction will be made small only in consideration of an actuator in the horizontal direction (i.e., horizontal fluid spring).

Moreover, The provision of the fluid bearing on the side of the horizontal actuator will lower the spring constant in the perpendicular direction.

In addition, in the present invention, since the fluid springs are utilized in both the perpendicular and horizontal directions, the spring constant in the perpendicular direction can be made small by increasing inner volume.

Further, the vibration isolation table device of the present invention is one for suppressing self-oscillation caused by micro-vibration from a floor or machine itself of a precision machine or equipment, and hence, can be widely utilized for industry required for isolating vibration in the use of various precise machine driving mechanisms or like.

1. A vibration isolation table device disposed directly or indirectly with respect to an object to be vibration-isolated for isolating vibration of the object, comprising:
a top plate directly or indirectly contacting the object;
suspending plates suspending from peripheral edges of the top plate; and
a base member covered by the top plate and the suspending plates,
wherein a perpendicular fluid spring and a fluid bearing are disposed sequentially between an inside surface of the top plate and the base member to be directed from the base member toward the inside surface of the top plate,
a horizontal fluid spring is disposed between an inside surface of the suspending plates and the base member, and
after the floating of the top plate and the suspending plates by the perpendicular fluid spring and performing a leveling operation, the top plate is floated in a non-contact state by the fluid bearing.

2. The vibration isolation table device according to claim 1, wherein the fluid bearing has substantially a cylindrical structure having an inner hollow portion, one substantially circular plane area, which contacts the inside surface of the top plate, of the cylindrical structure is formed as a porous sintered surface, another one substantially circular plane area opposing to the above-mentioned one circular plane area substantially contacts the perpendicular fluid spring, and pressurized fluid for the fluid bearing is supplied into the hollow portion of the cylindrical structure from the outside thereof.

3. The vibration isolation table device according to claim 1, wherein the perpendicular fluid spring is composed of a diaphragm having a rolling operation film structure or a bellows.

4. The vibration isolation table device according to claim 1, wherein the perpendicular fluid spring and the fluid bearing interposed between the inside surface of the top plate and the base member are arranged so as to support a load in the perpendicular direction, and the horizontal fluid spring interposed between the inside surface of the suspending plate and the base member is for horizontal positioning.

5. The vibration isolation table device according to claim 1, wherein the top plate and the suspending plates are integrated as floating structure and the base member has a function of fixing member.

6. The vibration isolation table device according to claim 1, wherein the perpendicular fluid spring is a diaphragm having a rolling operation film structure, in which: the base member is provided with a base member body having a fluid chamber, a flange member covering the base member body in a state communicated with the fluid chamber, and a cylinder constituting member integrally secured to a peripheral edge portion of the flange member; in combination of the flange member and the cylinder constituting member, the peripheral flange portion of the diaphragm is fixed and a cylinder portion of the rolling operation film is formed; and the fluid bearing constitutes a piston portion of the rolling operation film.

7. The vibration isolation table device according to claim 6, wherein pressurized fluid for the fluid spring is introduced into the fluid chamber formed to the base member body from an outside thereof, and the introduction of the pressurized fluid permits the rolling operation film to carry out rolling motion and permits the fluid bearing to vertically move.

8. The vibration isolation table device according to claim 1, wherein the perpendicular fluid spring is a bellows, in which: the bellows is provided with a pair of opposing ring-shaped surface portions and a side surface portion disposed so as to connect outer peripheral edge portions of the respective opposing surface portions to each other; the base member is provided with a base member body having a fluid chamber, and one of the ring-shaped opposing surface portions of the bellows is fixed onto the base member body in a state communicated with the fluid chamber; and another one of the ring-shaped opposing surface portions is substantially fixed to the fluid bearing.

9. The vibration isolation table device according to claim 8, wherein pressurized fluid for the fluid spring is introduced into the fluid chamber formed to the base member body from an outside thereof, and the bellows is expanded in an axial direction according to the introduction of the pressurized fluid so as to vertically move the fluid bearing.

10. The vibration isolation table device according to claim 1, wherein the horizontal fluid spring formed between an inside surface of at least one of suspending plates and the base member is either one of diaphragm having a rolling operation film structure, a bellows and a piston structure.

11. The vibration isolation table device according to claim 10, wherein the horizontal fluid spring and the fluid bearing are disposed sequentially between the inside surface of at least one of the suspending plates and the base member to be directed from the base member toward the inside surface of the suspending plate, and a non-contact state from the suspending plate is formed by the fluid bearing.
